(19) United States
(12) Patent Application Publication
(10) Pub. No.: US 2014/0279224 A1
(43) Pub. Date: Sep. 18, 2014

(54) SYSTEMS, METHODS AND COMPUTER READABLE MEDIA FOR ASSOCIATING MNEMONIC DEVICES WITH MEDIA CONTENT

(71) Applicant: Patrick Bridges, McKinney, TX (US)

(72) Inventor: Patrick Bridges, McKinney, TX (US)

(21) Appl. No.: 13/842,508

(22) Filed: Mar. 15, 2013

(51) Int. Cl. G06F 17/30; G06Q 30/06; G06F 3/0482

(52) U.S. Cl. CPC G06F 17/30244; G06F 3/0482; G06Q 30/0609
USPC 705/26.35; 707/736; 715/810; 715/808

(57) ABSTRACT

Systems and methods for associating mnemonic devices with media content are disclosed. An embodiment can include providing, with a processor, a primary content media source, and connecting a secondary image to the primary content media source by generating an association between the secondary image and the primary content media source, the secondary image adapted to visually depict a mnemonic representation of content of the primary media source. The method can also include storing the association between the secondary image and the primary media source in a third media item (e.g., a Memory Palace), and causing the secondary image to be displayed as a virtual layer of the primary media source in response to a request.

### FIELD

Embodiments relate generally to mnemonic devices, and more particularly, to associating mnemonic devices with media content.

### BACKGROUND

External memory agents such as phones, books, computers, are now common elements in society that can be used to augment our internal memory and cognitive capacities. These external memory agents are becoming so integrated into the daily activities of some users that it may be difficult for such users to get through the day without one or more of these external memory agents. These devices can be used to remind us of who to meet, where, and when. The devices can also remind us of what we need to do. Further, many users may no longer have a need to remember contact information such as phone numbers because the contact information is stored in the external memory agent.

Due in part on the increasing reliance on these external storage houses over the past 20 years, massive levels of investment have been made to expand the storage capacity and optimize the portability of these external agents. Meanwhile, insufficient investment may be being made to evolve the internal memory system that exists in each person. In fact, while these external memory agents have evolved by quantum leaps, the human brain's internal evolution may be inversely correlated. There is some belief that when an organ such as the brain is not challenged, it may become weaker (similar to the way muscle atrophies). If these theories are indeed true, then there may be a risk the brain's memory capacity may devolve (or regress in capacity) in the years to come as our reliance on external memory storage increases. And, with our internal memory pathways possibly degrading, another unique human function is at possible risk of decline: our ability to create and innovate.

The capacity for synthetic creativity, in other words combining known building blocks A and B to create something new C, may be in jeopardy as fewer and fewer of these building blocks (e.g., memories, knowledge or the like) are actually residing within our subconscious, and therefore may potentially become inaccessible by a person to combine, or synergize.

### SUMMARY

One or more embodiments may help reverse this possible downward trajectory of human memory. One or more embodiments can be based on the art of internal memorization using spatial references, known as the Method of Loci. The Method of Loci, as depicted in the book “Moonwalking with Einstein” by Joshua Foer, and also the “Art of Memory” by Frances Yates, outlines a technique for memorizing vast amounts of information. These techniques were utilized by the ancient Greeks who required superior internal memory storage for the passing of stories through oration. These same techniques are used by the memory athletes of today.

One or more embodiments may advance the internal knowledge of the mainstream consciousness through technology, instead of technology replacing our internal knowledge and memory capabilities. Also, one or more embodiments may provide a way of implanting knowledge deeply into the human memory on any subject, making it lasting, accessible, and protected from decay.

Through neuropsychological, structural, and functional brain imaging measures, it has been found that superior memory is not driven by exceptional intellectual ability or structural brain differences. Rather, superior memorizers engage brain regions critical for spatial memory. Sight may be the keenest of all human senses, therefore perceptions received through our other senses may be best remembered when attached to a visual sensation, according to Yates

The Method of the Loci is at its core a process for knowledge assumption achieved by associating a given piece of knowledge or information to a visual object and a space, thus employing the spatial areas of the brain that have been proven to create the most durable memory imprints. The memory of an element of knowledge is further deepened by the familiarity and uniqueness of the image that is associated with it.

An embodiment can include a system programmed with software to perform a method for providing a streamlined and integrated interface for digital Memory Palace knowledge associations with primary digital media sources including audio, written, and other online formats. The interface can enable improved user learning and retention of said content, through the use of the Method of Loci technique, which activates regions of the brain associated with spatial memory that have been proven helpful for memory assimilation and recall. An embodiment can also include a social network system for development and integration of the Memory Palaces for primary media content. An embodiment can also form contractual based partnerships for selling and re-selling of the Memory Palaces, and governance over rights of the secondary imagery mnemonic devices.

An embodiment can be used to create and provide Loci around complex bodies of information, such as law and medicine. An embodiment can include methods and systems for creating mnemonic imagery and spatial associations that can work not only for one person, but for many people. And, through the mnemonic systems and methods described herein, can be shared outside a single individual's internal imagination.

An embodiment can include systems and methods in which media (e.g., books, audio) could have a visual portrayal of the knowledge contained in the media superimposed upon the media content to improve the speed and accuracy of memorizing and recalling the content.

An embodiment can include a marketplace for knowledge packs (e.g., mnemonic devices corresponding to media content) based on the Method of Loci technique. In the marketplace embodiment, these knowledge packs can be commissioned for development, bought, sold and traded.

One embodiment includes a computer-implemented method for associating mnemonic devices with primary media content. In the method, a computer system can provide a primary media content. The system can connect a secondary image to the primary media content by generating an association between the secondary image and the primary media content. The secondary image can be adapted to visually depict a mnemonic representation of content of the primary media content

The system can store the association between the secondary image and the primary media content in a third media item, and cause the secondary image to be displayed as a virtual layer of the primary media content in response to a request. The primary media content can include one or more of the following: a portion of a book, a uniform resource locator, a video, a video game, unpublished material local to a users device, and an audio track.

The third media item can be a Memory Palace having Loci and Sub-loci. Secondary image associations to primary media content can be stored at a corresponding location within the Memory Palace. A Memory Palace can include a geographic location or building and can be adapted to store a variety of image associations throughout the Memory Palace.

The system can provide a menu of options for actions relating to the association between the primary media content and secondary images, the menu provided in response to receiving an indication that a user has selected a media segment from the primary content media and seeks to perform an action relating to the association. The indication can include an indication that the user has highlighted text. The request can be a user-generated request or an automatically generated request.

In one embodiment the system can store information including meta tag data when a selected portion of the primary media content has been associated with a selected portion of the secondary image. A tag can be the connection or association between the selected piece of the secondary image and a portion of primary media content. Therefore, a user could pull up the memory palace, and locate the secondary image that corresponds to a certain topic. The user can then click on hot-spots created within the image to pull up the link to the primary media content.

The system can cause to be displayed a map of current active and owned Memory Palace associations with the primary media content, the map showing a layout of the Memory Palace and hot spot links reflecting any existing memory associations. A map of a Memory Palace can be re-sized, and re-positioned around the user's primary source content screen.

The system can permit an end user to access a Memory Palace linked to the primary media content via secondary image associations, and navigate through the Memory Palace. The navigation through a Memory Palace can be based on one or more of a user specified sequence programmed for viewing the images, cursor selection of a specific Loci to view in a Memory Palace, by an automated random order, and a search method where the user can view image associations within the palace based on a search of all the association fields.

The system can store a set of data fields containing information related to the image association between the primary media content source and the secondary image, the set of data fields including: a) primary media content type, b) primary content source, c) identification code, d) primary media content name, e) primary media content author, f) primary media content class, g) primary media content subject, h) secondary image author, i) secondary image association status, j) secondary image contract type, k) primary media content detail, l) image association explanation, m) palace location and n) count of palaces referencing the primary media content.

The primary media content can be text and a plurality of text portions from a plurality of respective locations can be associated with a secondary image.

The system can automatically show an associated secondary image and corresponding mnemonic data field information in a pop up screen when a tagged segment of an audio track is reached. The system can also automatically show an associated secondary content image and corresponding mnemonic data field information in a pop up screen when a tagged segment of a video track is reached.

Another embodiment can include a computerized method for providing and controlling a marketplace for mnemonic devices (e.g., Memory Palaces, Loci and Sub-loci). According to the method, a system can provide a mnemonic device marketplace user interface adaptable to be used by sellers and buyers of Memory Palace, Loci and Sub-Loci, the interface having contract templates for Memory Palace, Loci, Sub-Loci transactions. The system can track contracts between buyers and sellers, the contracts including: a single user license, a purchase with resale rights and a revenue share agreement, the tracking including storing a copy of each contract.

The system can store ownership records identifying an owner of rights in a Memory Palace, Loci, and Sub-Loci based on one or more contracts stored within the system. The system can also administer payment transactions matching terms and conditions expressed in one of the contracts at a time of original sale and at a time of subsequent re-sale of a Memory Palace, Loci and Sub-Loci when a revenue sharing agreement exists.

The system can receive a rating of a Memory Palace, Loci, or Sub-Loci including a user review, and cause to be displayed an average rating based on the rating and the user review.

In one embodiment, the system can provide an auction interface adapted to permit users to create buyer or seller auctions for Memory Palace, Loci, or Sub-Loci content associations, the auctions including placing an image content association, or a request for creation thereof, at either the Memory Palace, Loci, or Sub-Loci level along with a contract up for bidding, wherein an auction can be selected to be viewable by one of an entire user community or a selected group of users.

System administrator approval of image associations and any description content may be required prior to being published in the marketplace. Changes to an image association can be submitted by a user, but must be approved by current owner of image, if the owner does not approve, then the change can exist at a requesting user's local computer only.

### BRIEF DESCRIPTION OF THE DRAWINGS

FIG. 1 shows a diagram of an example system for associating mnemonic devices with primary media content in accordance with at least one embodiment.

FIG. 2 shows a diagram of an example mnemonic device marketplace system in accordance with at least one embodiment.

FIG. 3 is a diagram of information associated with a mnemonic device in accordance with at least one embodiment.

FIG. 4 is a flow chart showing an example method of linking secondary mnemonic imagery with primary media content in accordance with at least one embodiment.

FIG. 5 is a diagram of an example mnemonic device server system (for linking/associating or marketplace) in accordance with at least one embodiment.

FIG. 6 is an example secondary image mnemonic device in accordance with at least one embodiment.

FIG. 7 is an example system for automatically creating secondary images in accordance with at least one embodiment.

### DETAILED DESCRIPTION

A Memory Palace can include a representation of a location with many compartments. For example, a Memory Palace takes the form of a mass structure (house) or a path (road) that contains many compartments or sections in it (Loci). A “clean memory palace” has no memory or knowledge associations tied to it. A “populated memory palace” consists of all the locations and all of its Loci, sub-loci and any knowledge associations tied to each. For example, a Memory Palace can represent a house with Loci rooms containing Sub-Loci knowledge associations related to law.

Loci can include sub-levels of a Memory Palace. For example, if the Memory Palace is a house, then the Loci could be the rooms of the house. If the Memory Palace is a street, then the Loci could be each block of the street. A “clean loci” has no sub-loci memory associations. A “populated loci” have sub-loci within it. For an example of a populated loci, in a Memory Palace house representing law, a room in the house can be associated with real estate law.

Sub-Loci can include specific images within Loci that are tied to unique knowledge elements. Within one Sub-Loci, there may be additional Sub-Loci embedded with additional associations. For example, picture of a man with pockets out, standing under a bird house of money resided on by a black crow, buttressed by branches with the words taxes and insurance on them, could represent the concept of an escrow account. In this example, the composition of the images of the man, crow, bird house, money, and words tax and insurance would all create the Sub-Loci association to the definition of escrow.

An association can include a connection made between a Memory Palace element (Memory Palace, Loci, Sub-Loci) and a given set of knowledge content (e.g., primary media content).

As shown in FIG. 1, an environment 100 for associating mnemonic devices with primary media content includes a mnemonic system 102 having a server device 104 and a mnemonic database 106. The environment 100 includes a plurality of client devices 108-112. Client device 112 has an associated data storage device 114. The environment 100 also includes a primary media content system 118 including a server device 120 and a primary content database 122.

In operation a user (e.g., U1-U3) can access the primary content system 118 for primary content media such as books, videos, music or audio recordings. The user can then associate a portion of primary media content with a mnemonic device (e.g., a secondary image) provided by the mnemonic system 102. The mnemonic system 102 can store a link (or tag) between the primary media content and the secondary image in the mnemonic database 106. The secondary image can be retrieved from the mnemonic database 106 or from a local storage (e.g., data storage 114).

The mnemonic system 102 can provide a user interface with a menu that is displayed after a user selects a media portion (e.g., highlights text or tags a location in an audio/video media content item). The menu can include the following selections/functions:
a. Create/Load Image Association
b. Search and purchase existing Image Associations
c. View/Add to Memory Palace
d. View Existing Image Association

Upon selecting the “Search and purchase existing Image associations” menu item, the system will cause a screen view of existing Memory Palaces, Loci, and Sub-Loci that are connected to the primary media content selected to be displayed. The user can view the Memory Palace association (with watermark), email the seller/author, or enter into a purchase agreement with the seller to use the image association.

Upon selecting “View/Add to a Memory Palace” the system will cause to be displayed a view of any Memory Palace, Loci, Sub-Loci that the user previously used for associations to the current primary media content. The user can expand the search beyond pre-existing associations if needed. The user will also have the opportunity from this screen to browse for previous Memory Palaces in their personal library that they would like to build an association to, or create a new Memory Palace, Loci, Sub-Loci. The interface can have a button that performs the function of adding an image association, wherein the user will be navigated to another screen where they can upload an image or request another user from the community to provide an image based on a message sent to the community or specific user(s).

Upon selecting the “View Existing Image Association” menu item, the system can cause to be displayed a view of any Memory Palace, Loci, and the specific Sub-Loci that the user has currently associated to the primary media content section. The user can update the meta tag information. The user can also relocate the Sub-Loci image to another Loci within the current Memory Palace, or move to another Memory Palace in its entirety.

Upon selecting the “Create/Load Image Association” the system will cause to be displayed a screen where the user can upload an image from their local computer. Once the image is loaded, the image can be linked to the selected portion of the primary media content.

To create a new Memory Palace, a user can upload an image or video into the system showing the outside view of a Palace. A user can also upload an image or video into the system that would represent a Loci within a given Palace. New Loci can be added at any time to the user's local version of the Palace through this method.

The system can provide the user with a toolbox in which they can edit the Loci directly. For example, they could insert text, draw pictures, insert shapes, and color. A user can also sequence the order in which Loci would appear in the Memory Palace.

The system can provide a view of a Memory Palace and its Loci in three different formats:

Card Deck Style—the user can order the Loci as needed, and then flip through each Loci one after the other similar to how a card dealer would reveal a card from a deck.

Map Style—the user can lay out all of the Loci adjacently creating a map. The order of the Loci in the Map Style layout is customizable. A user could have his first Locus start at the middle of the bottom row, the top right corner, for example. Each Locus can have the chronological sequence placed on it from which it would be walked.

3D-View—the user can take a 360 degree walk through the palace and encounter the Sub-Loci via this view.

In creating or populating a Memory Palace, a user can pull a segment from Google Streets, Earth and 3D and store as a Memory Palace, or Locus. A Memory Palace can have text references to Class, Description, Author, Creation Date, a count of the number of purchases, and a Rating system with contents. A user can search within his palace(s) for knowledge associations based on any fields connected to the palace's associations. This will permit the user to navigate directly to a desired Memory Palace/Locus/Sub-Locus.

In addition to Memory Palaces, a user can create a Mega Palace that includes more than one Memory Palace linked together. An example of a Mega Palace is as follows: A user has created a palace of the path Champs-Elyse. Along the walk of the Champs-Elyse is a Church. The user has established a Memory palace collection of all the rooms within the Church. The user is able to establish a link that takes him into the Church while walking down the Champs-Elyse palace path. Mega Palace links can be published automatically in a clean state, however a populated Mega Palace can be published in addition at the user's discretion.

The system can provide a user with a toolbox in which the user can edit Sub-Loci within a Locus directly. For example, the user can insert text, images, draw pictures, insert shapes, and attach a sound to images within the Locus. The user will be able to record sounds via the system that can be stored in the computer and attached to Loci and Sub-Loci images.

When a user is placing an image into the Locus, the user will have the option to place the object in the foreground or background or transparent in comparison to the images behind it. Default for a new object can be foreground.

Each Sub-Loci can have the following fields attached to it: Original source type, title, page or track, referenced knowledge text, sequence, and a Loci Method (e.g., an explanation of how the image is intended to translate into the referenced knowledge). A user can establish the sequence in which they would encounter each sub-loci.

The system can provide an ability to highlight an area of the Loci, and create a tag to store the relevant information text on that area: Class, Description, Author, Creation Date, Content link source, content link line/track, content association description, a count of the number of purchases, and a Rating system with contents.

The system can provide a link to a search engine for unique images and quickly insert them into an Object Level via drag and drop. Each image dropped into a Memory Palace object level will automatically be saved as an element within the Palace.

The system can provide an ability to select an area in a Locus via a grid based system consisting of columns labeled alphabetically with standard width, and rows labeled numerically, which could be engaged through voice, or pointer device. Upon engaging the associated grid cell, the user can then create a memory association. These grid locations can be used as reference points for forming an order for viewing the Loci/Sub-loci.

The system can include voice to text functionality to enable faster association building. For example, a user can speak the grid name they wish to build the association, and speak the text for the association.

The system can permit a user to send a request out to the community requesting a Sub-Loci creation. The request can include relevant information the Sub-Loci creator might need.

FIG. 2 shows a diagram of an example mnemonic device marketplace 200 that includes a mnemonic marketplace system 202 having a server device 204 coupled to a mnemonic database 206 adapted to store one or more Memory Palaces 208, Loci 210, Sub-loci 212 and other mnemonic devices or supporting materials 214. One or more sellers (216-220) can access the marketplace system 202 via a network 222. The Memory Palaces 208, Loci 210, Sub-loci 212 and other mnemonic devices or supporting materials 214 can be supplied by the sellers (216-220).

One or more buyers (224-228) can access the marketplace system 202 via a network 230 to purchase the Memory Palaces 208, Loci 210, Sub-loci 212 and other mnemonic devices or supporting materials 214. The networks 222 and 230 can be the same or different networks and can include a wired or wireless network.

In operation, the marketplace system 202 provides interfaces for buying and selling of mnemonic devices and associated materials (e.g., artwork). Within the marketplace, there are several types of licenses that can be purchased.

A license agreement would occur in a scenario where a buyer buys a perpetual license to use a Memory Palace, Loci, or Sub-Loci from a seller. The license may allow the Buyer to utilize a Palace, Loci, or Sub-Loci and edit them for their own local use only. Under a license agreement, the buyer cannot re-publish a seller's licensed Memory Palace, Loci or Sub-Loci for re-sale.

A purchase with re-sale option is used when a buyer would like to utilize the Memory Palace, Loci, or Sub-Loci as a component of a mnemonic project that will later be re-sold. The buyer will not be able to re-sell without making some modification or addition to the Palace, Loci, or Sub-Loci. In other words, they could not purchase a Clean Palace, and then publish the same Clean Palace without any changes.

A revenue share agreement can be formed when a buyer has made an agreement with a seller that any future proceeds of a re-sale will be shared at an agreed upon percentage. For example, let us say Person A creates a revenue share agreement with Person B for the use of an image Person B created which was then inserted into Person A's memory palace. In the revenue share agreement, Person A agrees to pay Person B $0.15 for each time the Memory Palace with that image is purchased by another user.

Revenue share agreements can be fixed fee or percentage based. Fixed fee revenue share includes a fixed dollar amount paid to seller upon each re-sale. Percentage revenue share includes a percentage of overall purchase price paid upon each re-sale.

In a Rights purchase, the ownership and rights to re-sale of the image are passed from the seller to the buyer. The buyer can then re-sell the image on its own, modified or un-modified from its original state, or as part of a Mnemonic project.

The marketplace system can support any of the above-mentioned agreement and fee sharing arrangements in addition to other agreements and arrangements. The marketplace system can have a query-able database in which Memory Palace content can be searched for, viewed, and purchased.

There can be three different “status” indictors for a Memory Palace, Locus or Sub-locus. Draft, which can indicate a user has started a Memory Palace but has not published it. Submitted—which can indicate a user has completed a Memory Palace and published it. Approved—which can indicate a user has published a Memory Palace, and the system admin has approved it for access by the community.

Within the marketplace, all populated objects can be queried by level (Memory Palace, Loci, Sub-Loci) on any information stored: class, description, author, creation Date, content link source, content link line/track, content association description, a count of the number of purchases, and a rating system with contents. If a user has found a Memory Palace, Loci, or sub-loci they wish to purchase, the user has the option to purchase the object clean (no knowledge associations) or they can purchase it with the associations. A user can submit a request direct to community users for an image or 360 video of a specific location around the world to other subscribed users.

The marketplace system permits a user to publish a created Locus on a topic, to rate published Loci, and to publish and collect a commission for sales of their Palace. Sellers of art can place commissioned pieces of art up for bid. A watermark can appear. Upon a buyer's purchase, the watermark will be removed from the image.

Financial transactions within the marketplace can be handled by a system such as Paypal or other similar systems that permit buyers and sellers to exchange money. A commission for each sale may be sent back to system owner. The marketplace system will need to track image ownership. Before any new image can be published, a system administrator may review the image, for example to confirm that nothing in its likeness exists already before approving publication. The system will need to track and administer to all the contract derivatives embedded within a Mnemonic project so that each transaction will automatically have funds dispersed in accordance with said contracts.

FIG. 3 is a diagram of an example mnemonic tag 300 for linking a secondary image to a selected portion of primary media content. The tag 300 includes a mnemonic tag field (302), a class (304) a description (306), an author (308), a creation date (310), a content link source (312) and a content link line/track (314).

Other information can also be stored in the system. For example, the system can store a set of data fields adapted to store information related to the image association between the primary media content source and the secondary image, the set of data fields can include:

a) primary content media type (e.g., audio file, Kindle ebook, Nook ebook, iBook, off-line book or URL). Additional file types can be added.
b) primary content source—URL or media source path to primary media content.
c) identification code (e.g., the ISBN of a book, or other unique identifier).
d) primary media content name—title of the primary media content (e.g., book name, or album name).
e) primary media content author (e.g., book author, or audio artist name).
f) primary media content class—a list of subjects in which the content pertains to (e.g., religion, philosophy). Multiple classes can be listed.
g) primary media content subject—free text area for keywords which would further identify the primary media content's subject matter.
h) image author—author name of the image associated with the primary media content.
i) image association status—image associations are local only to the user's computer unless they have chosen to publish or re-sell to other users. Status indicators include Local Only, Submitted, Approved.
j) image contract—shows what types of contracts are associated with the image (revenue share, licensed).
k) primary media content detail—contains the detail of the specific primary source segment that the image association will pertain to. In the example of a book, this field would contain the highlighted text from a paragraph.
l) image association explanation—contains a definition of how the image is meant to depict/explain the primary media source content. It is generally a dialog that describes the picture and its meaning.
m) palace location—provides a link to the path of where the image association is currently stored within a user's Memory Palace. May contain more than one path if the user has stored the image in multiple Palaces or Loci.
o) palaces—a count of the number of Palaces in which the image association is used. This count acts as a link that can pull up all memory palaces connected to the image association.

FIG. 4 is a flow chart showing an example method of linking secondary mnemonic imagery with primary media content in accordance with at least one embodiment. The process begins at 402, where a system provides primary media content such as an electronic book or other document or an audio or video recording.

At 404, a secondary image is connected to the primary media content. The secondary image can be a mnemonic device to help a user recall a portion of the primary media content associated with the secondary image. The connection can be implements using a tag as discussed above.

At 406, the association between the primary media content and the secondary image can be stored. The association can be stored in a Locus or Sub-locus within a memory palace.

At 408, the secondary image can be caused to be displayed as a virtual layer of the primary media content. For example, the secondary image can be shown adjacent to the primary media content, overlaid on the primary media content or shown as a replacement for the primary media content.

FIG. 5 is a diagram of an example server device 500 that can be used to create, distribute and cause to be displayed Memory Palaces, Loci and Sub-Loci. The server device 500 includes a processor 502, operating system 504, memory 506 and I/O interface 508. The memory 506 can include a mnemonic device engine 510 and an application program for mnemonic device association with primary media content and a mnemonic device marketplace 512.

In operation, the processor 502 may execute the application 512 stored in the memory 506. The application 512 can include software instructions that, when executed by the processor, cause the processor to perform operations for creating, using, buying and selling mnemonic devices in accordance with the present disclosure (e.g., performing one or more of steps 402-408 described above).

The application program 512 can operate in conjunction with the mnemonic engine 510 and the operating system 504.

FIG. 6 shows an example secondary image. The image of FIG. 6 is a secondary image mnemonic device designed to be associated with (or connected to) to a passage of the Bible (i.e., primary media content). The image in FIG. 6 was created to represent I Corinthians 3:5-9, which reads:
“What, after all, is Apollos? And what is Paul? Only servants, through whom you came to believe—as the Lord has assigned to each his task. I planted the seed, Apollos watered it, but God has been making it grow. So neither the one who plants nor the one who waters is anything, but only God, who makes things grow. The one who plants and the one who waters have one purpose, and they will each be rewarded according to their own labor. For we are co-workers in God's service; you are God's field, God's building.”

The mnemonic system could provide an explanatory walk through tour of the picture to explain the meaning of the symbols to the end reader and how they signify the passage's concept. FIG. 6 is an example of a secondary image that provides visual hooks to implant the memory of Corinthians I 5-9. Within this picture, hover over pop up windows will detail out how the associations are made, so the end user can internalize the association:

1. Apollos and Paul are the two main characters. Paul planting seeds of faith. Apollos watering.

2. However, nothing grows without Christ. Christ's hands giving the energy into the soil to help grow the people that are on the path to him.

3. There are many paths to Christ as depicted by the black paths (two of which connect to Paul and Apollos).

4. All paths originate from Christ. While the paths may be separate outside of Christ, they are unified and one inside him “no division”.

The picture could also include an identification of the passage number from Corinthians. Also, a Memory Palace itself could have these references (e.g., in a stadium Memory Palace, a row of seats in Section 1 Corinthians, Row 3, Seats 5-9).

FIG. 7 shows an example system for the automatic creation of secondary images. The application 701, in at least one of its embodiments, can parse text (or other media such as audio or video) provided to it by the user or by another system to extract or to abstract the concepts and relationships from the text in the form of (Subject, verb, object, adverbs, adjectives) and will use the concepts as they are related in the text to select elemental images from an image association engine 702 to visually represent these concepts.

The image association engine 702 in at least one of its embodiments will select elemental images based on concepts extracted from the primary media content. The image association engine 702 will select elemental images that are referenced by image concept tags 705 that most closely match the concepts extracted from the primary content. For example, to illustrate the concept “man driving a red car” the image association engine 702 may search and find one or more elemental images directly matching this tag “man driving a red car” and also return several elemental images separately matching the tags “man driving”, “red” and “car”.

The image association engine 702 in at least one of its embodiments will search and select elemental images from an image bank 703 using the image concept tags 705.

Where no single elemental image is available in the image bank 703 matching the entire concept extracted or abstracted from the primary media content, then multiple element images representing part of the concept will be passed to a create composite image application 704 to be combined into a composite secondary image. For example, the image bank might not contain a tagged image for the concept “man driving a red car” but may have a tagged image of a “man driving” with a golf club and separately tagged elemental pictures of a “car” and the color “red”.

The create composite image application 704 can automatically combine these images into a single secondary image to act as a mnemonic device for this primary content. In this example, it could create a composite image with the man holding the golf club connected to the car and the color red also connected to the car.

The server/system (e.g., 500 and/or 700) can include, but is not limited to, a single processor system, a multi-processor system (co-located or distributed), a cloud computing system, or a combination of the above. The client (or user) device can include, but is not limited to, a desktop computer, a laptop computer, a portable computer, a tablet computing device, a smartphone, a feature phone, a personal digital assistant, a media player, an electronic book reader, an entertainment system of a vehicle or the like. The network can be a wired or wireless network, and can include, but is not limited to, a WiFi network, a local area network, a wide area network, the Internet, or a combination of the above.

The data storage, memory and/or computer readable medium can be a magnetic storage device (hard disk drive or the like), optical storage device (CD, DVD or the like), electronic storage device (RAM, ROM, flash, or the like). The software instructions can also be contained in, and provided as, an electronic signal. Moreover, embodiments of the disclosed method, system, and computer readable media can be implemented in software executed on a programmed general purpose computer, a special purpose computer, a microprocessor, or the like.

It is, therefore, apparent that there is provided, in accordance with the various embodiments disclosed herein, systems and methods for associating mnemonic devices with media content.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A computer-implemented method comprising:
providing, with a processor, a primary media content;
connecting a secondary image to the primary media content by generating an association between the secondary image and the primary media content, the secondary image adapted to visually depict a mnemonic representation of content of the primary media content;
storing the association between the secondary image and the primary media content in a third media item; and
causing the secondary image to be displayed as a virtual layer of the primary media content in response to a request.

2. The method of claim 1, wherein the primary media content includes one of a book, a uniform resource locator, a video, a video game and an audio track.

3. The method of claim 1, wherein the third media item is a Memory Palace and image associations to primary media content can be stored at a corresponding location within the Memory Palace.

4. The method of claim 3, wherein a Memory Palace can include a geographic location or building and can be adapted to store a variety of image associations throughout the Memory Palace.

5. The method of claim 1, further comprising providing a menu of options for actions relating to the association between the primary media content and secondary images, the menu provided in response to receiving an indication that a user has selected a media segment from the primary content media and seeks to perform an action relating to the association.

6. The method of claim 5, wherein the indication includes an indication that the user has highlighted text.

7. The method of claim 1, wherein the request is one of a user-generated request or an automatically generated request.

8. The method of claim 1, further comprising storing information including meta tag data when a secondary image has been associated with a selected portion of the primary media content.

9. The method of claim 1, further comprising causing to be displayed a map of current active and owned Memory Palace associations with the primary media content, the map showing a layout of the Memory Palace and hot spot links reflecting any existing memory associations.

10. The method of claim 3, further comprising permitting an end user to access a Memory Palace linked to the primary media content via secondary image associations, and navigate through the Memory Palace.

11. The method of claim 10, wherein the navigation can be based on one or more of a user specified sequence programmed for viewing the images, cursor selection of a specific Loci to view in a Memory Palace, by an automated random order, and a search method where the user can view image associations within the palace based on a search of all the association fields.

12. The method of claim 3, further comprising a set of data fields adapted to store information related to the image association between the primary media content source and the secondary image, the set of data fields including:
a) primary media content type;
b) primary content source;
c) identification code;
d) primary media content name;
e) primary media content author;
f) primary media content class;
g) primary media content subject;
h) image author;
i) image association status;
j) image contract type;
k) primary media content detail;
l) image association explanation;
m) palace location; and
n) count of palaces.

13. The method of claim 1, wherein the primary media content is text and a plurality of text portions from a plurality of respective locations are associated with a secondary image.

14. The method of claim 1, further comprising automatically showing an associated secondary image and corresponding mnemonic data field information in a pop up screen when a tagged segment of an audio track is reached.

15. The method of claim 1, further comprising automatically showing an associated secondary content image and corresponding mnemonic data field information in a pop up screen when a tagged segment of a video track is reached.

16. A computerized method comprising:
providing, with a processor, a mnemonic device marketplace user interface adaptable to be used by sellers and buyers of Memory Palace, Loci and Sub-Loci, the interface having contract templates for Memory Palace, Loci, Sub-Loci transactions;
tracking, with the processor, contracts between buyers and sellers, the contracts including: a single user license, a purchase with resale rights and a revenue share agreement, the tracking including storing a copy of each contract;
storing ownership records identifying an owner of rights in a Memory Palace, Loci, and Sub-Loci based on one or more contracts stored within the system; and
administering payment transactions matching terms and conditions expressed in one of the contracts at a time of original sale and at a time of subsequent re-sale of a Memory Palace, Loci and Sub-Loci when a revenue sharing agreement exists.

17. The method of claim 16, further comprising receiving a rating of a Memory Palace, Loci, or Sub-Loci including a user review; and
causing to be displayed an average rating based on the rating and the user review.

18. The method of claim 16, further comprising providing an auction interface adapted to permit users to create buyer or seller auctions for Memory Palace, Loci, or Sub-Loci content associations, the auctions including placing an image content association, or a request for creation thereof, at either the Memory Palace, Loci, or Sub-Loci level along with a contract up for bidding, wherein an auction can be selected to be viewable by one of an entire user community or a selected group of users.

19. The method of claim 16, wherein system administrator approval of image associations and any description content prior to being published in the marketplace.

20. The method of claim 16, wherein changes to an image association can be submitted by a user, but must be approved by current owner of image, if the owner does not approve, then the change can exist at a requesting user's local computer only.
